(19) United States
(12) Patent Application Publication
(10) Pub. No.: US 2026/0259891 A1
(43) Pub. Date: Sep. 3, 2026

(54) METHODS, SYSTEMS, ARTICLES OF MANUFACTURE, AND APPARATUS TO EXTRACT, TRANSFORM AND LOAD NATURAL LANGUAGE DATA FOR SELECTIVE MODEL EXECUTION

(71) Applicant: Nielsen Consumer LLC, Chicago, IL (US)

(72) Inventors: Sowndarya Krishnamoorthy, Brampton (CA); Vincent McLoughlin, Chicago, IL (US); Petar Radosevic, Barcelona (ES); Jorge Martín, Laguna de Duero (ES); Roberto Arroyo, Guadalajara (ES)

(21) Appl. No.: 19/343,599

(22) Filed: Sep. 29, 2025

Related U.S. Application Data
(60) Provisional application No. 63/765,973, filed on Mar. 3, 2025.

(51) Int. Cl. G06F 16/25; G06F 16/334

(52) U.S. Cl. CPC G06F 16/254; G06F 16/3347

(57) ABSTRACT

Methods, system, articles of manufacture, and apparatus to extract, transform and load natural language data for selective model execution are disclosed. An example apparatus includes interface circuitry, machine-readable instructions, and at least one processor circuit to be programmed by the machine-readable instructions to: generate first vectors corresponding to a first database, the first vectors respectively based on tuples of the first database, generate a query vector based on a query intended for a large language model (LLM), determine respective similarity scores between (a) the query vector and (b) the first vectors of the first database, prevent transmission of the query vector to the LLM based on the similarity score satisfying a similarity threshold value, and generate an output corresponding to the query vector based on data associated with the first vectors of the first database.

### RELATED APPLICATION

This patent claims the benefit of U.S. Provisional Patent Application No. 63/765,973, which was filed on Mar. 3, 2025. U.S. Provisional Patent Application No. 63/765,973 is hereby incorporated herein by reference in its entirety. Priority to U.S. Provisional Patent Application No. 63/765,973 is hereby claimed.

### FIELD OF THE DISCLOSURE

This disclosure relates generally to query response systems and, more particularly, to methods, systems, articles of manufacture, and apparatus to extract, transform and load natural language data for selective model execution.

### BACKGROUND

Natural language models have allowed users of systems to ask questions and receive answers (Q & A) that are generated by artificial intelligence (AI) agents. User interaction with such Q & A agents provides on-demand answers without human-based support teams.

### BRIEF DESCRIPTION OF THE DRAWINGS

FIG. 1 is a block diagram of an example environment in which example model query circuitry operates to improve model query efficiency.

FIG. 2 is a block diagram of an example implementation of the model query circuitry of FIG. 1.

FIGS. 3-6 are flowcharts representative of example machine readable instructions and/or example operations that may be executed, instantiated, and/or performed by example programmable circuitry to implement the model query circuitry of FIG. 2.

FIG. 7 is a block diagram of an example processing platform including programmable circuitry structured to execute, instantiate, and/or perform the example machine readable instructions and/or perform the example operations of FIGS. 3-6 to implement the model query circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Artificial Intelligence (AI) is giving an added value in several business use cases to automate and optimize different tasks. There are varied innovations based on different Machine Learning (ML) and Deep Learning (DL) approaches able to reduce manual burden and improve the efficiency of computing processes. In some examples, text inputs and natural language tasks can benefit by these technologies. Natural Language Processing (NLP) is an area of AI focused on combining computational linguistics, ML and DL models to process and understand human language.

Using text inputs and natural language by applying NLP models have been increased due to advancements in technologies based on Generative AI (GenAI), such as LLMs (Large Language Models) and architectures based on GPT (Generative Pre-Trained Transformer). Recent advancements with GenAI improves industry objectives based on a capacity to reason about different inputs like text or natural language, which can be interpreted by GenAI models to generate outputs for users. Some GenAI solutions can be used for enhancing customer support, building personalized engagement, reducing wait times, facilitating operator training, automating repetitive tasks, optimizing network strategies, reducing costs and improving customer satisfaction and retention.

Chatbots are able to solve problems, answer questions, and directly interact with users in an automated way. Standard GPT services are focused on general questions, so they are not effective in solving questions for specific knowledge domains, such as pharmaceutical medication recommendations, automated drug deliveries to patient rooms, market analysis trends, product shipment instructions, etc. Examples disclosed herein address these voids and obtain semantic knowledge from natural language documents related to specific knowledge domains. Examples disclosed herein also utilize frequently asked questions (FAQ) to dynamically adjust based on question and answer gaps (e.g., voids of semantic relationships) that standard GPT solutions fail to solve and/or otherwise address.

While standard LLM pre-trained models can be fine-tuned with specific data to particular task or knowledge domain, they require extra computational costs for training, and suffer from computationally expensive re-training efforts in view of new or updated data. An alternative is the usage of Retrieval-Augmented Generation (RAG), which enhances accuracy and reliability of GenAI models with facts fetched from external sources. RAG is able to ground outputs in up-to-date data, improving the quality and reliability of the generated text, without changing the model itself. However, even with benefits of RAG enabling updated data to be considered for query processing, reliance upon LLM model participation occurs to process revised prompts based on RAG assistance.

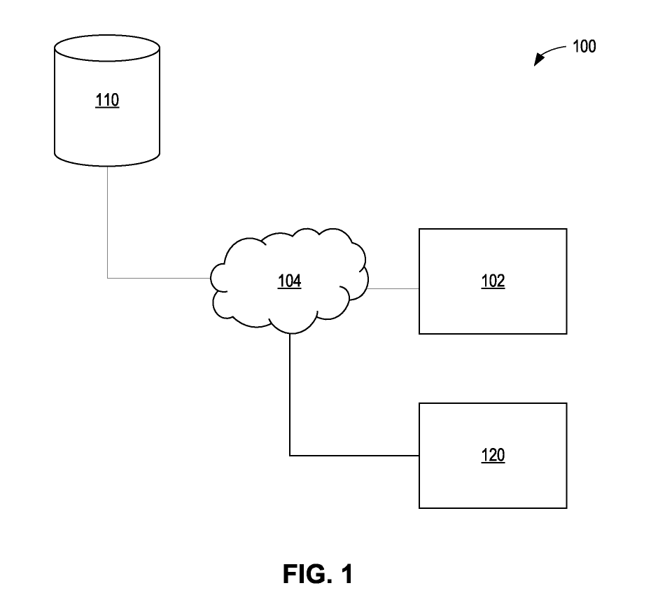

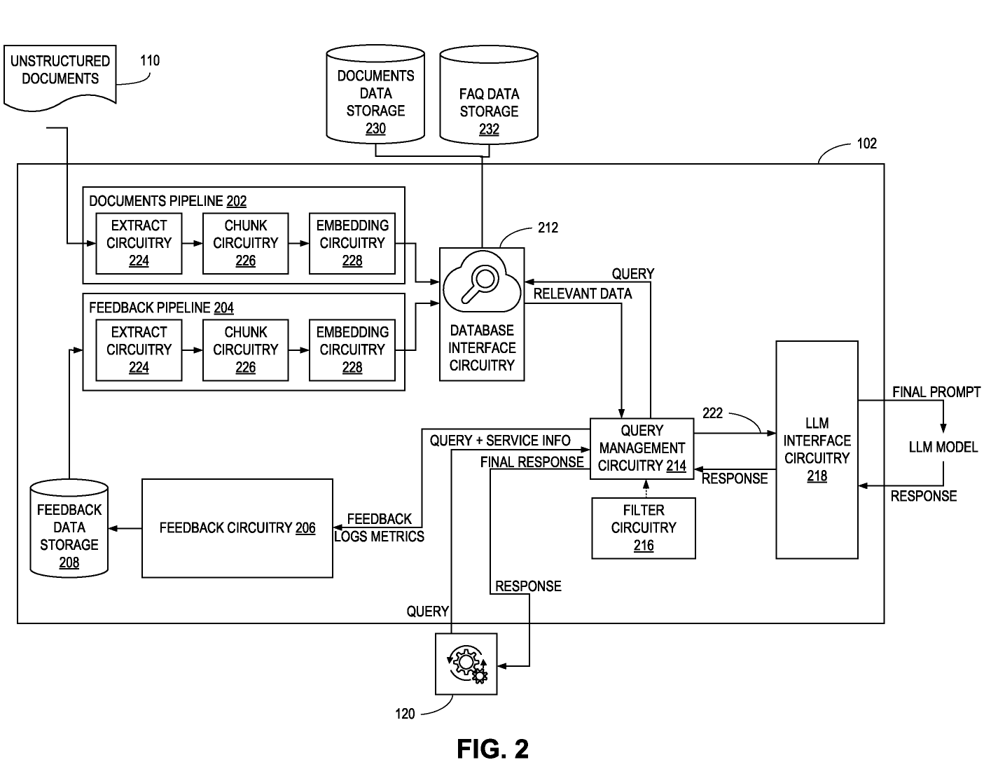

FIG. 1 is a block diagram of an example environment 100 in which example model query circuitry 102 operates to extract, transform and load natural language data for selective model execution. In the illustrated example of FIG. 1, the environment 100 includes a network 104 communicatively coupled to the model query circuitry 102 and a document corpus 110, such as one or more databases containing information (e.g., natural language terms, sentences, etc.) associated with a particular subject matter focus (e.g., pharmaceutical drug names, sports product sales, shipment distribution schedules, airline supply chain schedules, etc.). As described in further detail below, examples disclosed herein generate and modify a documents data storage (see element 230 of FIG. 2 below) based on information from the document corpus 110. While the document corpus 110 may have any and all available documents in an unstructured format, the example documents database described in further detail below is an example data storage that is built with vector embeddings having a particular dimension density to enable semantic searching. The example environment 100 also includes query interface circuitry 120 communicatively connected to the network 104.

In operation, the model query circuitry 102 receives queries to be processed by a model, such as a large language model (LLM) that has been trained in a manner specific to one or more of the particular subject matter focus topics. Generally speaking, an LLM trained on subject matter specific data is more likely to return query results that are relevant and reduce occurrences of model hallucination. Prompts to an LLM are derived from natural language queries, such as queries drafted by users of a query system. Because users may not draft prompts that result in relevant answers, known LLM prompt development techniques use the document corpus 110 and/or the documents database 230 to modify raw user queries in a manner that results in LLM prompts that result in improved query results. As such, these known techniques to query models involve the task of submitting the developed prompt to the LLM to derive an answer. With every query, the model (e.g., LLM) consumes a finite amount of energy to derive an answer.

Examples disclosed herein reduce query energy consumption and/or otherwise allow the environment 100 to generate query results in a relatively more efficient manner compared to known techniques to execute models in connection with a query. As described in further detail below, some queries include word and/or terminology combinations that have occurred on prior occasions, in which answers reside in traditional data sources (e.g., databases associated with frequently asked questions (FAQs)). Computational efforts to extract data from traditional databases typically consume less energy than computational efforts corresponding to inference from a machine learning model. Examples disclosed herein identify opportunities to bypass relatively higher-energy consuming model prompt tasks when traditional databases include responses indicative of high quality answers (e.g., answers associated with threshold cosine similarity scores).

FIG. 2 is a block diagram of an example implementation of the model query circuitry of FIG. 1 to extract, transform and load natural language data for selective model execution. The model query circuitry of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the model query circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the model query circuitry 102 includes an example documents pipeline 202, an example feedback pipeline 204, example feedback circuitry 206, an example feedback data source 208, example database interface circuitry 212, example query management circuitry 214, example filter circuitry 216, and example LLM interface circuitry 218, which includes an LLM input 222. The example documents pipeline 202 and the example feedback pipeline 204 include respective extract circuitry 224, chunk circuitry 226, and embedding circuitry 228. In the illustrated example of FIG. 2, the database interface circuitry 212 is communicatively connected to an example documents data storage 230 and an FAQ data storage 232. In some examples, the FAQ data storage 232 and the feedback data source 208 (e.g., sometimes referred to as the feedback database 208) are the same data storage device. In some examples, modifications to the feedback database 208 are directed to tuples of question/answer pairs and a corresponding feedback threshold score.

In operation, the example query management circuitry 214 determines whether a query is received by the example model query circuitry 102. If so, the example database interface circuitry 212 determines if the received query includes a prior indication of positive feedback, in which the query terms are stored in a first data storage (e.g., the FAQ data storage 232). In some examples, the first data storage is a database that includes tuples of information in the form of questions and corresponding answers, in which the first data storage is sometimes referred to herein as an FAQ database 232. If the database interface circuitry 212 determines that the query includes a matching tuple in the FAQ database 232, it retrieves vectors associated with the matching tuple to decode a corresponding answer in a natural language to be provided in response to the query (e.g., provided to a user of the example model query circuitry 102).

The filter circuitry 216 examines the natural language answer for questions and corresponding answers that are to be withheld from further display or dissemination. In some examples, a user of the example model query circuitry 102 is identified with user credentials, which are further associated with particular access privileges. For instance, a first user having first credentials may be associated with a first entity (e.g., a first entity in a first geographical region subject to particular information restrictions, such as General Data Protection Regulation (GDPR) guidelines), such as a business and its respective data. However, because the document corpus 110 and the documents data storage 230 that are accessible to the model query circuitry 102 may be owned and/or otherwise associated with any number of separate entities, the filter circuitry 216 prevents dissemination of data from one entity to another entity. In some examples, the filter circuitry 216 provides and/or otherwise embeds context information (e.g., context awareness) with a user query, such as information related to a particular page (e.g., a webpage) that the user is viewing when the query is submitted.

The example query management circuitry 214 prevents and/or otherwise bypasses a prompt request to the example LLM interface circuitry 218 (e.g., prevents the prompt request that is intended for and/or otherwise propagating to the LLM input 222) to avoid computational resource consumption by one or more models (e.g., an LLM) when the answer to the query is available in the FAQ database 232). Examples disclosed herein first determine if a query (e.g., a user question) has a corresponding answer in the FAQ database 232. If so, that answer is used instead of any further requests to be performed by the model (e.g., an LLM). Stated differently, the query management circuitry 214 prevents transmission of the query vector to the LLM input 222 when the query is available in the FAQ database 232. If the question from the user is not in the FAQ database 232, then a main vector database (e.g., the documents database 230) is used to cause transmission of a prompt to the LLM to generate an answer to the query. Stated differently, because the model query circuitry 102 determines that invocation of the LLM interface circuitry 218 and its associated model(s) is not necessary, substantial amounts of computational energy are conserved by retrieving the answer to the query from the FAQ database 232.

However, in some examples, the database interface circuitry 212 does not find a match between the received query and a corresponding tuple in the FAQ database 232. In some examples, even if the database interface circuitry 212 finds a matching tuple in the FAQ database 232, if the matching tuple does not satisfy a feedback threshold score or include a success parameter (or does not have a corresponding feedback threshold score calculated on a prior occasion), then the example embedding circuitry 228 generates a similarity score based on the query vector and one or more vectors in the FAQ database 232. In some examples, the FAQ database 232 is dynamically updated over time as queries are received and evaluated with updated answers from the FAQ database 232, in which some updated answers cause a different feedback threshold score. For instance, a first query to the FAQ database 232 at a first time may include a first tuple having a response that does not properly answer and/or otherwise address the query. In such examples, the feedback circuitry 206 embeds a success parameter with the tuple indicative of a relatively low value (e.g., a relatively low feedback threshold score). However, a second query to the FAQ database 232 at a second time after the first time may include a second tuple having a response that receives a positive feedback input, which is indicative of an answer that is more directly related to the query. In such examples, the feedback circuitry 206 embeds a success parameter with the tuple that is indicative of a relatively high value (e.g., a relatively high feedback threshold score).

To generate the similarity score, the example extract circuitry 224 of the example feedback pipeline 204 extracts and parses questions and corresponding answers from the feedback data storage 208 (sometimes referred to as the feedback database 208). The chunk circuitry 226 of the feedback pipeline 204 segments (e.g., sometimes referred to as “chunking”) portions of the feedback database 208 based on context window parameters of the model to be used by the model query circuitry 102. For example, an LLM model may have particular size constraints of information it can process at one time. In some examples, the chunk circuitry 226 creates segments based on semantic information (e.g., portions of a database associated with pharmaceutical drug nomenclature, portions of a database associated with seasonal sales trend information, etc.). In some examples, the chunk circuitry 226 creates segments based on header division(s), or character/token quantities. In some examples, the chunk circuitry 226 creates segments (“chunks”) and also cleans the data, converts the data into standardized plain text, and further divides the segments into respective sizes that can be processed by a downstream embedding transformer. As described in further detail below, the segments are used during query retrieval efforts to perform semantic searches of vectors so that they can be compared to the query input.

The example embedding circuitry 228 of the feedback pipeline 204 selects an embedding dimension target parameter for a transformer to be used for vector embedding generation. The embedding circuitry 228 uses an embedding model (e.g., the transformer), in which vector embeddings represent an internal representation of data of the selected model (e.g., deep learning model, sentence transformer, etc.). Sentence transformers convert sentences into dense vector representations, such as a first dimensional vector (e.g., 384 dimensions) associated with the FAQ database 232, and a second dimensional vector (e.g., 1536 dimensions) associated with the documents database 230. The models (sentence transformers) may be trained on different dimensional targets to establish values that enable sufficient semantic meaning for sentence matching (e.g., matching a query vector with a database vector). The embedding circuitry 228 generates first vectors corresponding to the first database of interest (e.g., the FAQ database 232), which are based on respective tuples of the first database. Additionally, the embedding circuitry 228 generates a vector corresponding to the query. In typical LLM query systems, the vector is provided to the LLM to cause the LLM to operate on the query, but examples disclosed herein enable opportunities to block, bypass and/or otherwise prevent such automatic LLM invocation when it is not needed.

In some examples, a particular dimensional density of the dimensional vector allows subsequent clustering activities to operate in a more efficient manner, such as an ability to generate vector clusters for K-nearest neighbor (KNN) analysis (e.g., or other nearest neighbor algorithm). While examples disclosed herein consider text-based embedding models and corresponding text-based data, examples are not limited thereto. In some examples the underlying data includes images in which corresponding embedding models are image-based transformers.

As discussed above, example generated vectors include a corresponding dimension parameter (e.g., an embedding dimension) that affects semantic detail of the vector. As the dimension parameter increases to a relatively higher value, a corresponding semantic detail improves with greater granularity. However, increasing the dimension parameter of the embedding model also increases an amount of time, and an amount of energy consumed by the embedding model. Stated differently, selection of the dimension parameter involves a tradeoff between semantic detail, time, and energy consumption. A single dimension in a vector embedding may be considered too abstract to have meaning or value. Examples disclosed herein utilize a first dimension parameter for the FAQ database 232, and a second dimension parameter for the documents database 230, in which the first dimension parameter is lower than that of the second dimension parameter. In some examples, the first dimension parameter generates the FAQ database 232 with 384 dimensions, and the second dimension parameter generates the documents database 230 with 1536 dimensions. The example values may be determined in an empirical manner to balance computational power requirements and speed. As such, because examples disclosed herein make a first attempt to find a matching tuple to the input query using the FAQ database 232, instances of a match proceed by using a relatively lower amount of computational energy.

After the embedding circuitry 228 transforms the segments into vector embeddings based on the selected dimension target parameter, the embedding circuitry 228 calculates similarity scores between the indexed vector(s) of the transformed segments and the query vector. In some examples, the embedding circuitry 228 uses a cosine similarity function to determine the similarity scores. The embedding circuitry 228 determines if the similarity score satisfies a similarity threshold and, if so, causes the query management circuitry 214 to bypass the model prompt query (e.g., bypass the LLM input) to provide an answer from the FAQ database 232. Stated differently, relatively higher similarity scores between (a) vectors of the query and (b) vectors of the FAQ database 232 enable model query efficiency improvements because LLM activity is bypassed and/or otherwise reduced. In some examples, the embedding circuitry 228 generates a list of similarity scores, and in some examples, the embedding circuitry 228 generates a ranked list of the similarity scores to identify a relatively highest similarity score. In some examples, the similarity threshold is a value indicative of how similar two vectors need to be for them to be considered a match. The similarity threshold may be determined through experimentation and/or empirical observation to ensure that only the most relevant results are returned to increase a quality of the search. In some examples, a similarity threshold value of 0.88 is deemed acceptable to enable accurate results while balancing precision and recall effort of the underlying computational resources.

On the other hand, if the embedding circuitry 228 determines that the similarity score does not satisfy the similarity threshold, the embedding circuitry 228 generates a similarity score based on the query vector and one or more vectors of the documents database 230. In particular, the extract circuitry 224 of the documents pipeline 202 extracts and parses information from the documents database 230 (which is derived from the documents corpus 110), and the chunk circuitry 226 of the documents pipeline 202 segments portions of the documents database 230 based on context window parameters of the model (e.g., an LLM) to be used by the model query circuitry 102.

The embedding circuitry 228 of the documents pipeline 202 selects an embedding dimension target parameter for the transformer model. As described above, the embedding dimension target parameter for the transformer model in connection with the documents database 230 reflects the second dimension parameter that is greater than the first dimension parameter of the FAQ database 232. As a result, the selected model is able to generate outputs having a relatively greater amount of semantic context (e.g., so that a greater degree of accuracy is associated with the output). In other words, any future feedback associated with the model output may be associated with a tuple stored in the FAQ database 232 to indicate an improved output result, thereby allowing a future bypass of the LLM for circumstances where a similar/same user query occurs.

The embedding circuitry 228 transforms the indexed vector embeddings based on the dimension target parameter, such as the second dimension parameter, and calculates similarity scores between the query vector and the indexed vector embeddings of the document corpus (e.g., the documents database 230). The embedding circuitry 228 identifies and selects the top K segments to be used for LLM prompt generation. The query management circuitry 214 modifies an LLM prompt based on the relatively highest ranked vectors that emerge from the top K segments determined by a K-nearest neighbor (KNN) analysis of the segments. The LLM interface circuitry 218 transmits the query and the associated modified LLM prompt to the LLM to generate an output.

In some examples, the query management circuitry 214 processes the FAQ database 232 and/or the documents database 230 on a periodic and/or scheduled basis so that vector embeddings are prepared for receipt of future input queries. Stated differently, transformer models associated with the FAQ database 232 and the documents database 230 are trained in advance (e.g., in view of particular dimension density values) of query analysis so that relatively faster inference operations occur in response to receiving one or more user queries.

In some examples, the query management circuitry 214 instantiates the feedback circuitry 206 during downtime or during instances where an active query to the model query circuitry 102 is not occurring. In the event that the feedback circuitry 206 determines an instance of feedback for one or more of the tuples in the FAQ database 232, the feedback circuitry 206 revises and/or otherwise embeds vectors of the FAQ database 232 in view of this new feedback (either positive feedback input or negative feedback input).

In some examples, the feedback circuitry 206 updates a score associated with the vector embeddings (e.g., tuples having a question and an associated answer) in response to instances of feedback input. In some examples, after the model query circuitry 102 delivers and/or otherwise transmits an output based on a query, a user of the model query circuitry 102 provides an indication of feedback. In some examples, the indication of feedback is a thumbs-up selection or a thumbs-down selection. In some examples, the indication of feedback includes sentence-based feedback in the form of commentary written by the user. In such cases, auditors may evaluate the commentary to cause modifications to scores associated with the tuples.

The feedback circuitry 206 determines if the score associated with the vector embeddings satisfies the feedback threshold score described above. If not, then the tuple (e.g., the question and corresponding answer) is considered unhelpful and/or otherwise inaccurate. In some examples, the feedback circuitry 206 removes and/or otherwise purges the associated vector from the FAQ database 232. However, in the event the score associated with the vector embeddings satisfies the feedback threshold score, then the feedback circuitry 206 maintains the tuple in the FAQ database 232. In some examples, the feedback circuitry 206 increases a relative score of a tuple in response to positive feedback, and decreases a relative score of a tuple in response to negative feedback.

In some examples, the model query circuitry 102 processes the query output to cause one or more actions. The example one or more actions may be instantiated by the model query circuitry 102 based on output from the FAQ database 232 (e.g., in which LLM model instantiation is bypassed and/or otherwise prevented), or based on output from an LLM model instantiated by the LLM interface circuitry 218 (e.g., in which the LLM is provided the user query and an enhanced prompt). In some examples, the model query circuitry 102 uses the query output to cause a particular medication to be dispatched via robotic delivery from a hospital medical facility to a particular patient room. In some examples, the query output causes a particular app or computer program to be instantiated on a computing device (e.g., an app of a mobile device, a service of a mobile device (e.g., GPS), a product shipment delivery control system, etc.). In some examples, the model query circuitry 102 uses the query output to render a particular graphical user interface (GUI) on a display device (e.g., render a relevant first GUI display rather than other (e.g., second) GUI displays that are less relevant to the query).

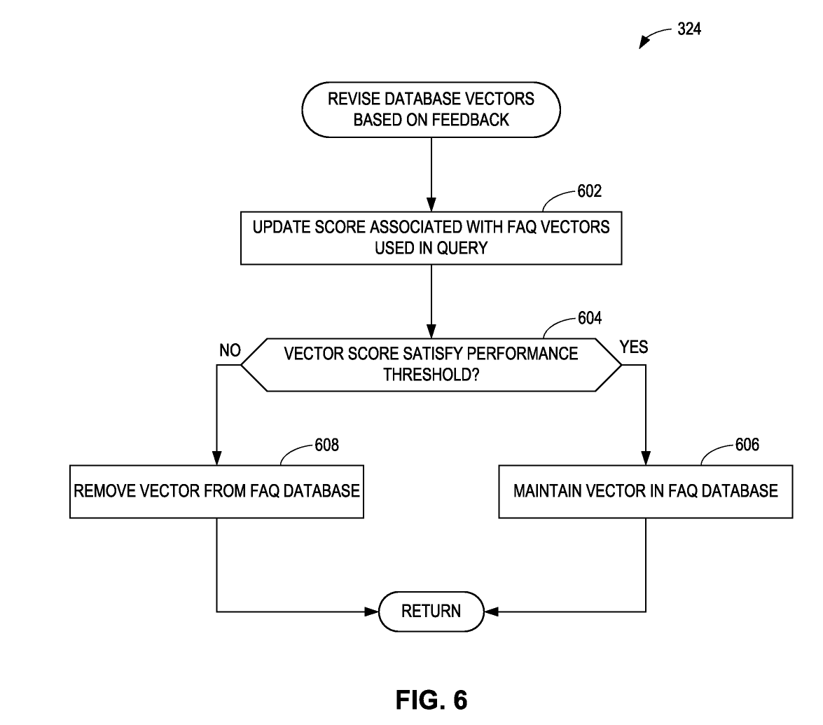

In some examples, the feedback circuitry 206 is instantiated by programmable circuitry executing feedback instructions and/or configured to perform operations such as those represented by the flowchart(s) of FIG. 6.

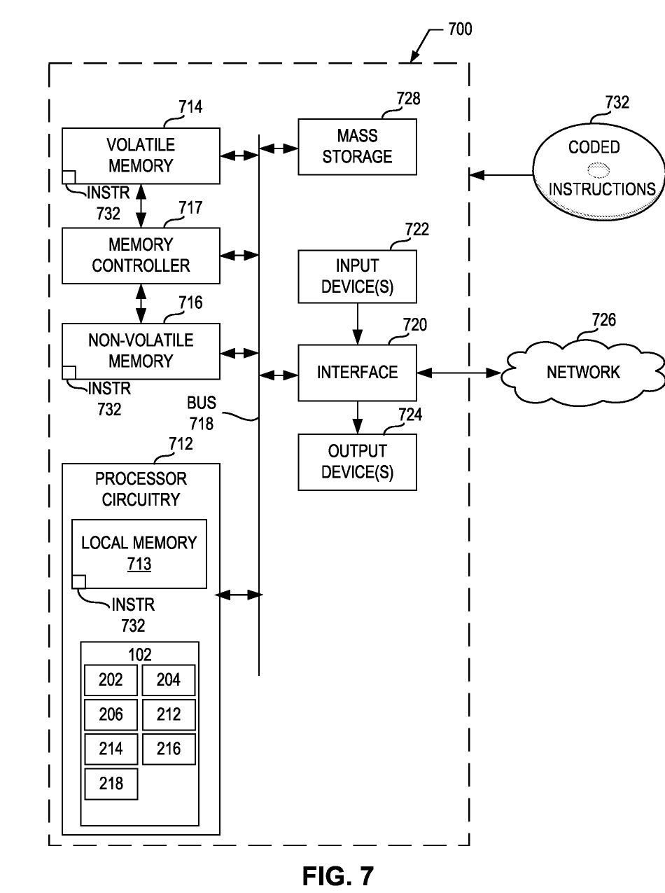

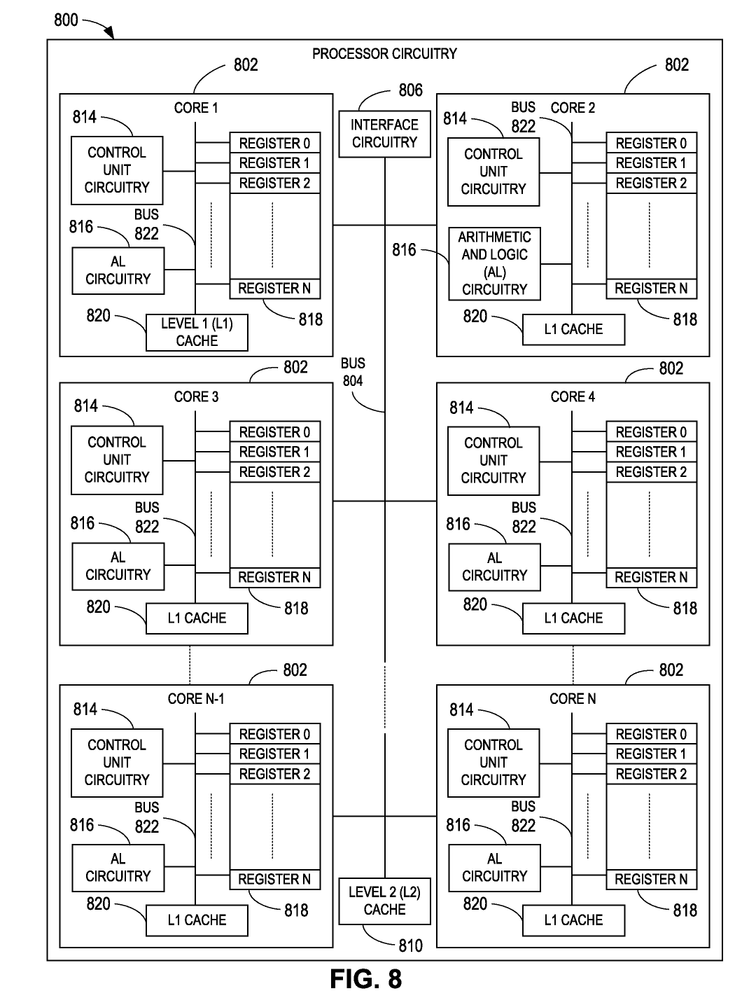

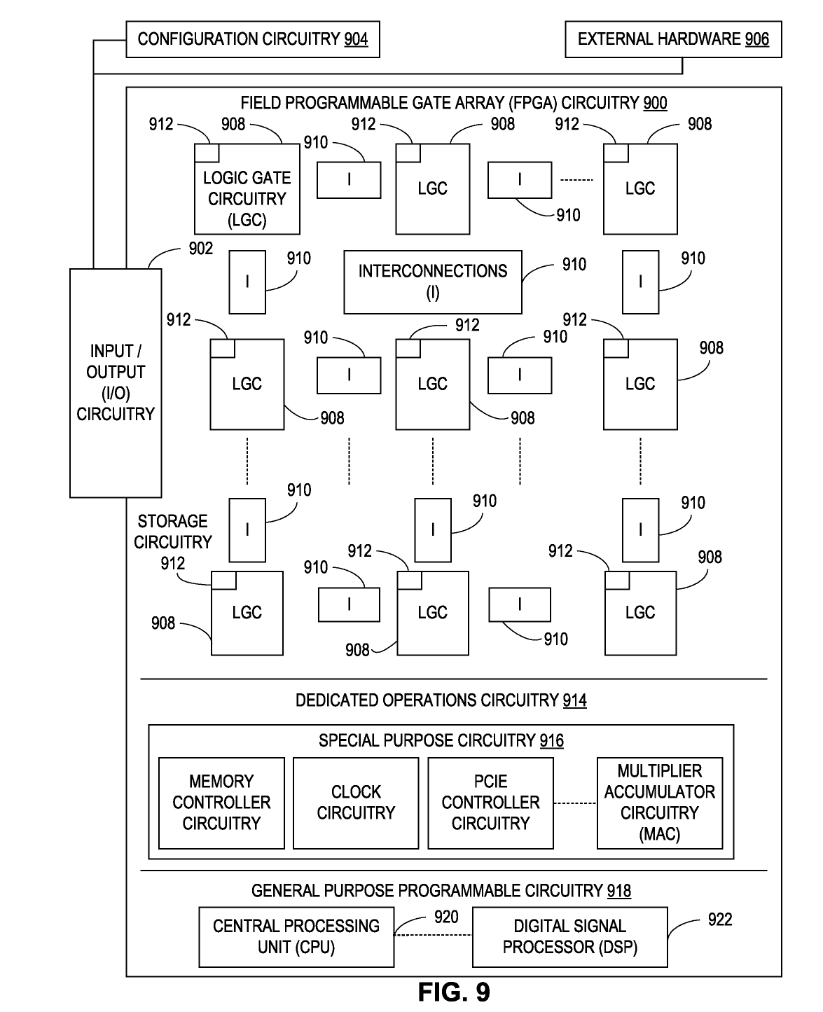

In some examples, the model query circuitry includes means for feedback management. For example, the means for feedback management may be implemented by feedback circuitry 206. In some examples, the feedback circuitry 206 may be instantiated by programmable circuitry such as the example programmable circuitry 712 of FIG. 7. For instance, the feedback circuitry 206 may be instantiated by the example microprocessor 800 of FIG. 8 executing machine executable instructions such as those implemented by at least blocks 602-608 of FIG. 6. In some examples, the feedback circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the feedback circuitry 206 may be instantiated by any other combination of hardware, software, and/or firmware. For example, the feedback circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

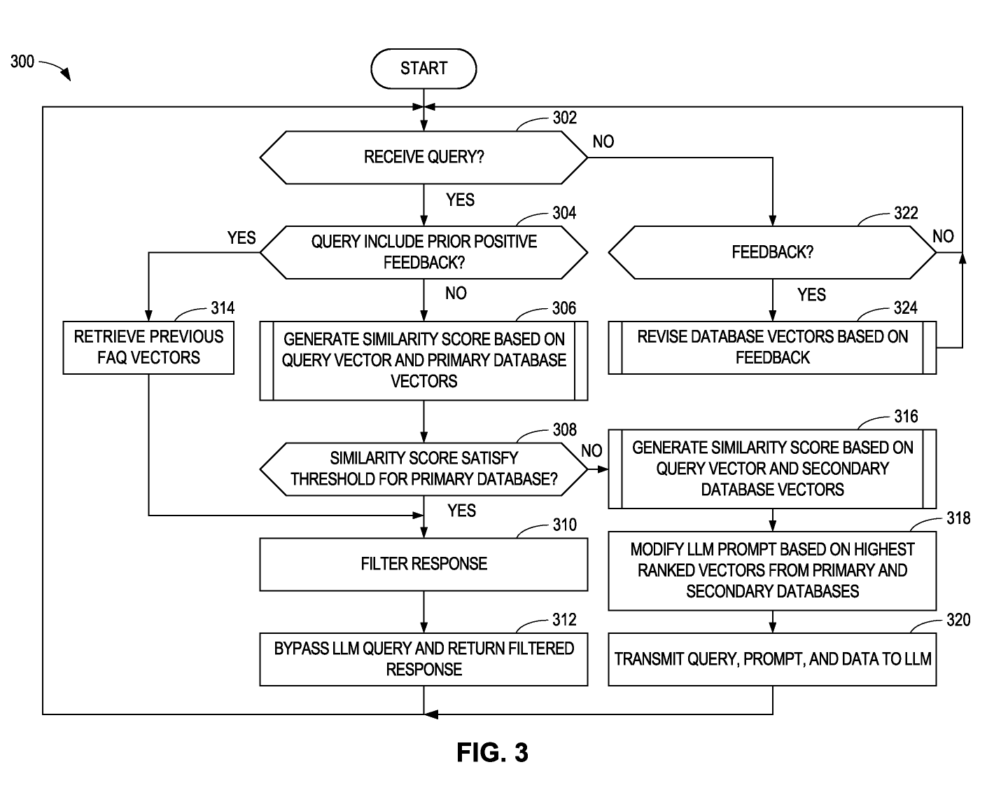

In some examples, the database interface circuitry 212 is instantiated by programmable circuitry executing database interface instructions and/or configured to perform operations such as those represented by the flowchart(s) of FIGS. 3-6.

In some examples, the model query circuitry includes means for database communication. For example, the means for database communication may be implemented by database interface circuitry 212. In some examples, the database interface circuitry 212 may be instantiated by programmable circuitry such as the example programmable circuitry 712 of FIG. 7. For instance, the database interface circuitry 212 may be instantiated by the example microprocessor 800 of FIG. 8 executing machine executable instructions such as those implemented by at least blocks 304 and 314 of FIG. 3. In some examples, the database interface circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the database interface circuitry 212 may be instantiated by any other combination of hardware, software, and/or firmware. For example, the database interface circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the query management circuitry 214 is instantiated by programmable circuitry executing query management instructions and/or configured to perform operations such as those represented by the flowchart(s) of FIGS. 3-6.

In some examples, the model query circuitry includes means for query management. For example, the means for query management may be implemented by query management circuitry 214. In some examples, the query management circuitry 214 may be instantiated by programmable circuitry such as the example programmable circuitry 712 of FIG. 7. For instance, the query management circuitry 214 may be instantiated by the example microprocessor 800 of FIG. 8 executing machine executable instructions such as those implemented by at least blocks 312 and 318 FIG. 3. In some examples, the query management circuitry 214 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the query management circuitry 214 may be instantiated by any other combination of hardware, software, and/or firmware. For example, the query management circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the LLM interface circuitry 218 is instantiated by programmable circuitry executing model interface instructions and/or configured to perform operations such as those represented by the flowchart(s) of FIGS. 3-6.

In some examples, the model query circuitry includes means for model interfacing. For example, the means for model interfacing may be implemented by LLM interface circuitry 218. In some examples, the LLM interface circuitry 218 may be instantiated by programmable circuitry such as the example programmable circuitry 712 of FIG. 7. For instance, the LLM interface circuitry 218 may be instantiated by the example microprocessor 800 of FIG. 8 executing machine executable instructions such as those implemented by at least block 320 of FIG. 3. In some examples, the LLM interface circuitry 218 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the LLM interface circuitry 218 may be instantiated by any other combination of hardware, software, and/or firmware. For example, the LLM interface circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the extract circuitry 224 is instantiated by programmable circuitry executing extraction instructions and/or configured to perform operations such as those represented by the flowchart(s) of FIGS. 3-5.

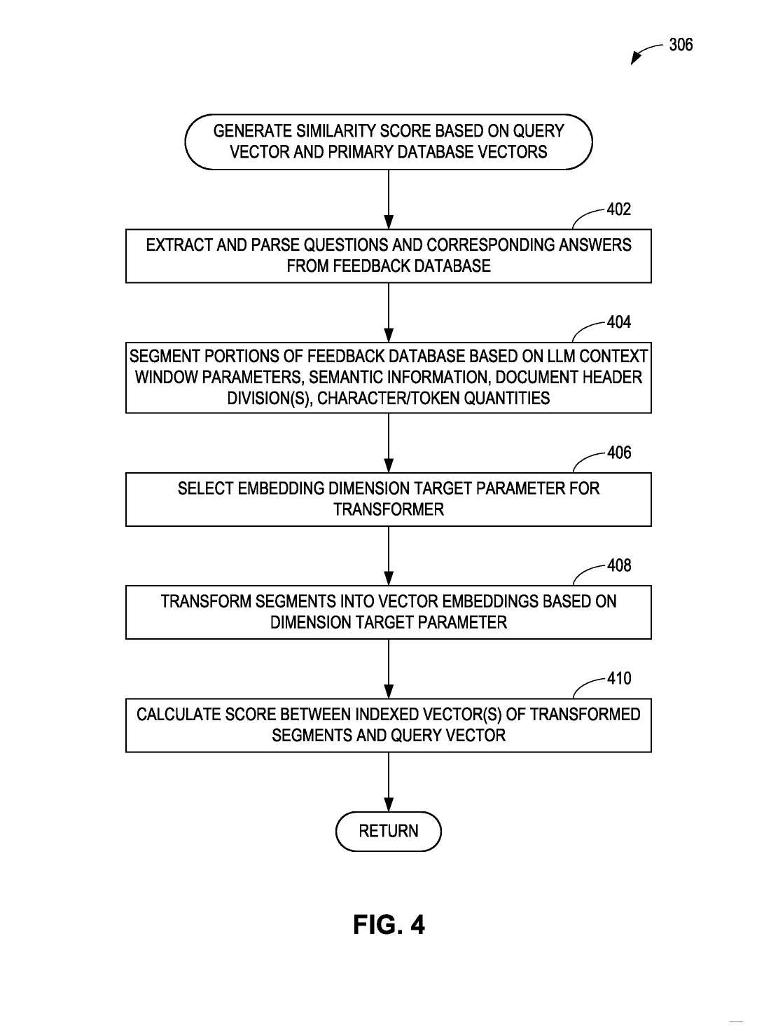

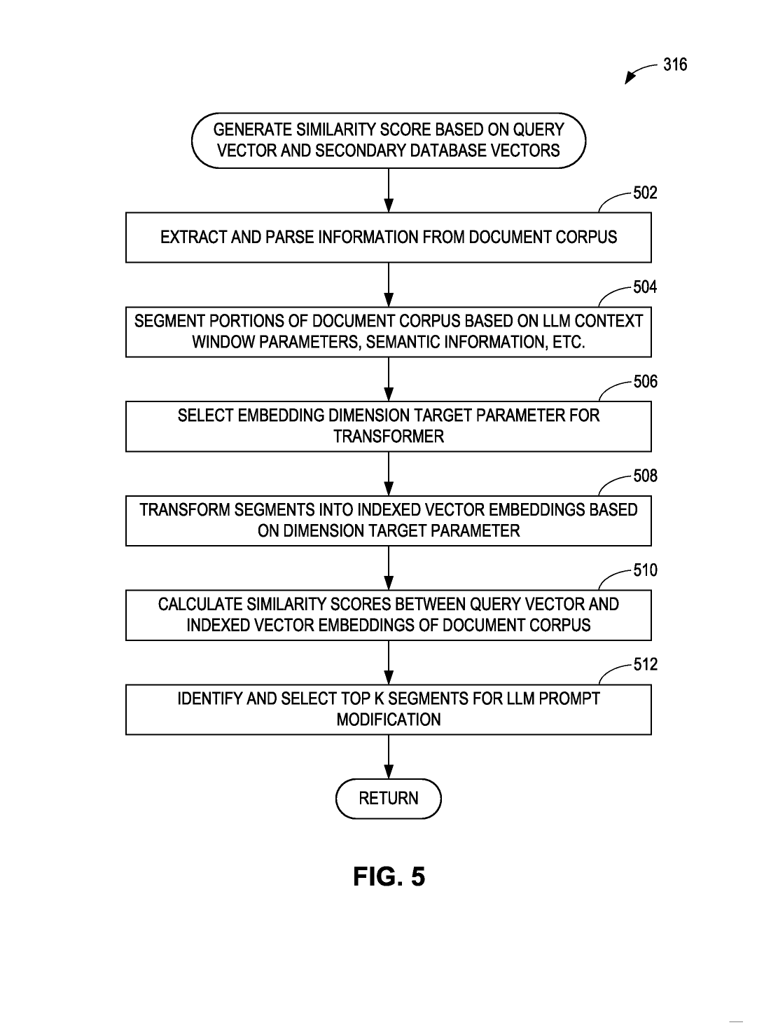

In some examples, the model query circuitry includes means for extraction. For example, the means for extraction may be implemented by extract circuitry 224. In some examples, the extract circuitry 224 may be instantiated by programmable circuitry such as the example programmable circuitry 712 of FIG. 7. For instance, the extract circuitry 224 may be instantiated by the example microprocessor 800 of FIG. 8 executing machine executable instructions such as those implemented by at least blocks 402 and 502 of FIGS. 4 and 5. In some examples, the extract circuitry 224 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the extract circuitry 224 may be instantiated by any other combination of hardware, software, and/or firmware. For example, the extract circuitry 224 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the chunk circuitry 226 is instantiated by programmable circuitry executing chunking and/or segmentation instructions and/or configured to perform operations such as those represented by the flowchart(s) of FIGS. 4 and 5.

In some examples, the model query circuitry includes means for segmentation (sometimes referred to herein as means for chunking). For example, the means for segmentation may be implemented by chunk circuitry 226. In some examples, the chunk circuitry 226 may be instantiated by programmable circuitry such as the example programmable circuitry 712 of FIG. 7. For instance, the chunk circuitry 226 may be instantiated by the example microprocessor 800 of FIG. 8 executing machine executable instructions such as those implemented by at least blocks 402 and 502 of FIGS. 4 and 5. In some examples, the chunk circuitry 226 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the chunk circuitry 226 may be instantiated by any other combination of hardware, software, and/or firmware. For example, the chunk circuitry 226 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the embedding circuitry 228 is instantiated by programmable circuitry executing embedding instructions and/or configured to perform operations such as those represented by the flowchart(s) of FIGS. 3-5.

In some examples, the model query circuitry includes means for embedding. For example, the means for embedding may be implemented by embedding circuitry 228. In some examples, the embedding circuitry 228 may be instantiated by programmable circuitry such as the example programmable circuitry 712 of FIG. 7. For instance, the embedding circuitry 228 may be instantiated by the example microprocessor 800 of FIG. 8 executing machine executable instructions such as those implemented by at least blocks 306, 308, 316, 406, 408, 410, and 506-512 of FIGS. 3-5. In some examples, the embedding circuitry 228 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the embedding circuitry 228 may be instantiated by any other combination of hardware, software, and/or firmware. For example, the embedding circuitry 228 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the model query circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example feedback circuitry 206, the example database interface circuitry 212, the example query management circuitry, the example filter circuitry, the example LLM interface circuitry 218, the example extract circuitry 224, the example chunk circuitry 226, the example embedding circuitry 228, and/or, more generally, the example model query circuitry of FIG. 2, may be implemented by hardware alone or by hardware in combination with software and/or firmware. Thus, for example, any of the example feedback circuitry 206, the example database interface circuitry 212, the example query management circuitry, the example filter circuitry, the example LLM interface circuitry 218, the example extract circuitry 224, the example chunk circuitry 226, the example embedding circuitry 228, and/or, more generally, the example model query circuitry of FIG. 2, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example model query circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the model query circuitry of FIG. 2 and/or representative of example operations which may be performed by programmable circuitry to implement and/or instantiate the model query circuitry of FIG. 2, are shown in FIGS. 3-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example model query circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to extract, transform and load natural language data for model execution. The example machine-readable instructions and/or the example operations 300 of FIG. 3 begin at block 302, at which the query management circuitry 214 determines whether the model query circuitry 102 receives a query. If so, the example database interface circuitry 212 determines if the query includes data and/or metadata associated with a prior instance of positive feedback (block 304). If so, the example database interface circuitry 212 retrieves vectors from the FAQ database 232 corresponding to the prior positive feedback instance and its corresponding output data (block 314). The example filter circuitry 216 filters the output data in view of one or more restrictions to prevent unauthorized users of the environment 100 from obtaining, viewing and/or otherwise receiving sensitive data (block 310). As described above, the filter circuitry 216 prevents a first user associated with a first entity from obtaining data (e.g., sensitive data, privileged data) from a second user associated with a second entity. The example query management circuitry 214 bypasses any query attempts to the LLM input 222 (e.g., via the LLM interface circuitry 218) and, instead, returns the query output/response after it is filtered (block 312).

However, in the event the database interface circuitry 212 does not identify data and/or metadata associated with a prior instance of positive feedback (block 304), then the example embedding circuitry 228 generates a similarity score based on a query vector and one or more vectors of a primary database (block 306), such as the FAQ database 232. FIG. 4 includes additional detail corresponding to the generation of the similarity score of block 306. In the illustrated example of FIG. 4, the example extract circuitry 224 extracts and parses questions and corresponding answer from the FAQ database 232 (block 402). The example chunk circuitry 226 segments portions of the FAQ database 232 based on any number of parameters to allow proper cooperation with a selected model (block 404). As described above, while an LLM is discussed herein, examples are not limited thereto. In some examples, the chunk circuitry 226 creates segmented portions of data based on particular model input data size constraints, particular semantic divisions of data, particular data header divisions, and/or particular quantities of characters or tokens in the data. The example embedding circuitry 228 selects an embedding dimension target parameter (e.g., a dimension density parameter) for the model that is to encode the segments (e.g., a transformer model) (block 406). The embedding circuitry 228 uses the selected transformer model to transform segments into vector embeddings based on the selected dimension target (block 408), and calculates a score between the indexed vectors of the transformed segments and the input query vector (block 410). Control returns to block 308 of FIG. 3.

The example embedding circuitry 228 determines if the similarity score satisfies a similarity threshold (block 308) and, if so, control advances to block 310 as described above. On the other hand, if the similarity score does not satisfy the similarity threshold (block 308), then the example embedding circuitry 228 generates a similarity score based on the query vector and vector(s) associated with a secondary database (block 316), such as the example documents database 230. FIG. 5 includes additional detail corresponding to the generation of the similarity score of block 316. In the illustrated example of FIG. 5, the example extract circuitry 224 extracts and parses information from the documents database 230. The example chunk circuitry 226 selects portions of the documents database 230 based on LLM context window parameters, such as particular group size constraints established by the LLM model (block 504).

The example embedding circuitry 228 selects an embedding dimension target parameter for the transformer to be used (block 506), such as a target parameter value having a relatively higher dimension density (e.g., 1536 dimensions) as compared to that of the FAQ database 232 (e.g., 384 dimensions). The embedding circuitry 228 transforms the segments into indexed vector embeddings based on the selected dimension target parameter (block 508), and calculates similarity scores between the query vector and the indexed vector embeddings of the documents database 230 (block 510). The embedding circuitry 228 applies a KNN model to identify and select a number of relatively closest clustered segments to be used for LLM prompt modification (block 512). Control then returns to block 318 of FIG. 3.

The example query management circuitry 214 modifies an LLM prompt based on the relatively highest ranked vectors from the primary and secondary databases (block 318), such as from the FAQ database 232 and the documents database 230, respectively. The example LLM interface circuitry 218 transmits the query, the modified prompt, and the associated database data to the LLM input 222 to cause generation of an output (block 320). Control then returns to block 302, where the example query management circuitry 214 continues to monitor for one or more queries (e.g., from a user of the example model query circuitry 102.

In the event the feedback circuitry 206 determines feedback has been received and/or otherwise provided (block 322), it revises database vectors based on such feedback in a dynamic manner (block 324). FIG. 6 includes additional detail corresponding to the processing of received feedback of block 324. In the illustrated example of FIG. 6, the feedback circuitry 206 updates scores associated with vectors of the FAQ database 232 that were associated with a prior query (block 602). In some examples, particular tuples and their associated vectors are modified to include a relatively higher score (e.g., a score increment) in response to positive feedback, such as an incremented count of positive feedback instances. In some examples, particular tuples and their associated vectors are modified to include a relatively lower score (e.g., a score decrement) in response to negative feedback, such as a decrement count of negative feedback instances.

The example feedback circuitry 206 determines if particular ones of the vectors in a feedback database 208 or the FAQ database 232 satisfy a feedback threshold score (block 604). If so, then the feedback circuitry 206 maintains and/or otherwise keeps the associated vectors and/or tuples in the FAQ database 232 to be used in a subsequent query occurrence (block 606). On the other hand, if the feedback circuitry 206 determines particular ones of the vectors in the feedback database 208 do not satisfy the feedback threshold score (block 604), then the feedback circuitry 206 removes the associated vectors and/or tuples from the FAQ database 232 so that they are not used in response to future queries (block 608). Control then returns to block 302 of FIG. 3.

FIG. 7 is a block diagram of an example programmable circuitry platform 700 structured to execute and/or instantiate the example machine-readable instructions and/or the example operations of FIGS. 3-6 to implement the model query circuitry of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad^{TM}), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example feedback circuitry 206, the example database interface circuitry 212, the example query management circuitry, the example filter circuitry, the example LLM interface circuitry 218, the example extract circuitry 224, the example chunk circuitry 226, the example embedding circuitry 228, and the example model query circuitry 102.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 900 may be configured and/or structured to effectively instantiate some or all of the operations/functions corresponding to the machine readable instructions of the flowchart(s) of FIGS. 3-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 3-6, and/or an ASIC may be configured and/or structured to perform third operation(s)/function(s) corresponding to a third portion of the machine readable instructions represented by the flowcharts of FIGS. 3-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

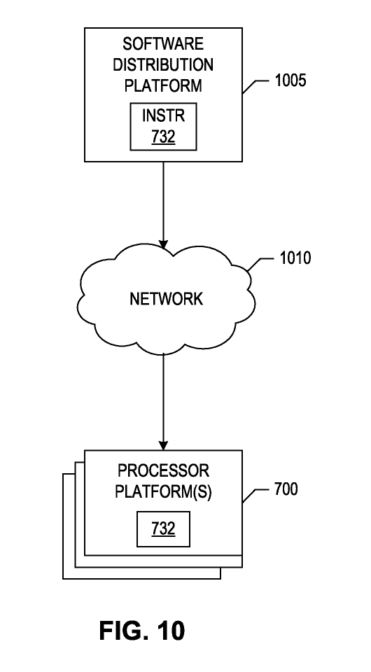

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 3-6, may be downloaded to the example programmable circuitry platform 700, which is to execute the machine readable instructions 732 to implement the model query circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/- 10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +/- 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve computing system efficiency in response to model queries. Examples disclosed herein evaluate input queries to determine whether relevant and/or otherwise useful answers to such queries may be found in one or more databases rather than allowing all queries to be processed by relatively more computationally burdensome models. Examples disclosed herein build and update one or more databases of answers to queries that exhibit indications of validity, quality and/or relevance to a given query. Examples disclosed herein dynamically update the one or more databases (e.g., frequently asked question (FAQ) databases) so that answers having a likelihood of relevance can be provided as output while bypassing energy intensive model invocation, such as LLM queries. In some examples disclosed herein, query answers cause automatic invocation of services, such as launching particular executables, launching particular apps, and/or causing automatic medication deliveries to patient rooms. Disclosed systems, apparatus, articles of manufacture, and methods improve the efficiency of using a computing device by avoiding excessive energy consumption by computational devices that would otherwise invoke AI/ML systems to derive answers and/or perform services. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods, systems, articles of manufacture, and apparatus to extract, transform and load natural language data for selective model execution are disclosed herein. Further examples and combinations thereof include the following:

Example 1 includes an apparatus comprising interface circuitry, machine-readable instructions, and at least one processor circuit to be programmed by the machine-readable instructions to generate first vectors corresponding to a first database, the first vectors respectively based on tuples of the first database, generate a query vector based on a query intended for a large language model (LLM), determine respective similarity scores between (a) the query vector and (b) the first vectors of the first database, prevent transmission of the query vector to the LLM based on the similarity score satisfying a similarity threshold value, and generate an output corresponding to the query vector based on data associated with the first vectors of the first database.

Example 2 includes the apparatus as defined in example 1, wherein the respective tuples include a question and a corresponding answer.

Example 3 includes the apparatus of any one or more of examples 1-2, wherein one or more of the at least one processor circuit is to generate the first vectors based on a first dimension density.

Example 4 includes the apparatus as defined in example 3, wherein one or more of the at least one processor circuit is to generate second vectors corresponding to a second database based on the similarity score not satisfying the similarity threshold value.

Example 5 includes the apparatus as defined in example 4, wherein one or more of the at least one processor circuit is to generate the second vectors based on a second dimension density greater than the first dimension density.

Example 6 includes the apparatus of any one or more of examples 4-5, wherein one or more of the at least one processor circuit is to determine a second similarity score between (a) the query vector and (b) ones of the second vectors of the second database.

Example 7 includes the apparatus as defined in example 6, wherein one or more of the at least one processor circuit is to cause transmission of a prompt to the LLM based on ranked ones of the second vectors having a relatively highest similarity score.

Example 8 includes the apparatus as defined in example 7, wherein one or more of the at least one processor circuit is to apply a nearest neighbor algorithm to identify respective ones of the second vectors having the relatively highest similarity score.

Example 9 includes the apparatus of any one or more of examples 3-8, wherein one or more of the at least one processor circuit is to instantiate a sentence transformer to generate the first vectors based on the first dimension density, and generate second vectors corresponding to a second database based on the similarity score not satisfying the similarity threshold value.

Example 10 includes the apparatus of any one or more of examples 1-9, wherein generating the output causes one or more of the at least one processor circuit to render a first graphical user interface (GUI) display.

Example 11 includes the apparatus of any one or more of examples 1-10, wherein one or more of the at least one processor circuit is to embed a success parameter in the respective tuples of the first database.

Example 12 includes the apparatus as defined in example 11, wherein one or more of the at least one processor circuit is to increment the success parameter of first ones of the respective tuples associated with a positive feedback input, and decrement the success parameter of second ones of the respective tuples associated with a negative feedback input.

Example 13 includes the apparatus of any one or more of examples 1-12, wherein the first database is a frequently-asked-questions (FAQ) database, the tuples of the FAQ database including a plurality of questions and corresponding answers.

Example 14 includes At least one non-transitory machine-readable medium comprising machine-readable instructions to cause at least one processor circuit to at least generate first vectors corresponding to a first database, the first vectors respectively based on tuples of the first database, generate a query vector based on a query intended for a large language model (LLM), determine respective similarity scores between (a) the query vector and (b) the first vectors of the first database, prevent transmission of the query vector to the LLM based on the similarity score satisfying a similarity threshold value, and generate an output corresponding to the query vector based on data associated with the first vectors of the first database.

Example 15 includes the at least one non-transitory machine-readable medium of example 14, wherein the machine-readable instructions are to cause one or more of the at least one processor circuit to generate the first vectors based on a first dimension density.

Example 16 includes the at least one non-transitory machine-readable medium of example 15, wherein the machine-readable instructions are to cause one or more of the at least one processor circuit to generate second vectors corresponding to a second database based on the similarity score not satisfying the similarity threshold value.

Example 17 includes the at least one non-transitory machine-readable medium of example 16, wherein the machine-readable instructions are to cause one or more of the at least one processor circuit to generate the second vectors based on a second dimension density greater than the first dimension density.

Example 18 includes the apparatus of any one or more of examples 16-17, wherein the machine-readable instructions are to cause one or more of the at least one processor circuit to determine a second similarity score between (a) the query vector and (b) ones of the second vectors of the second database.

Example 19 includes the at least one non-transitory machine-readable medium of example 18, wherein the machine-readable instructions are to cause one or more of the at least one processor circuit to cause transmission of a prompt to the LLM based on ranked ones of the second vectors having a relatively highest similarity score.

Example 20 includes the at least one non-transitory machine-readable medium of example 19, wherein the machine-readable instructions are to cause one or more of the at least one processor circuit to apply a nearest neighbor algorithm to identify respective ones of the second vectors having the relatively highest similarity score.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate first vectors corresponding to a first database, the first vectors respectively based on tuples of the first database;
generate a query vector based on a query intended for a large language model (LLM);
determine respective similarity scores between (a) the query vector and (b) the first vectors of the first database;
prevent transmission of the query vector to the LLM based on the similarity score satisfying a similarity threshold value; and
generate an output corresponding to the query vector based on data associated with the first vectors of the first database.

2. The apparatus as defined in claim 1, wherein the respective tuples include a question and a corresponding answer.

3. The apparatus as defined in claim 1, wherein one or more of the at least one processor circuit is to generate the first vectors based on a first dimension density.

4. The apparatus as defined in claim 3, wherein one or more of the at least one processor circuit is to generate second vectors corresponding to a second database based on the similarity score not satisfying the similarity threshold value.

5. The apparatus as defined in claim 4, wherein one or more of the at least one processor circuit is to generate the second vectors based on a second dimension density greater than the first dimension density.

6. The apparatus as defined in claim 4, wherein one or more of the at least one processor circuit is to determine a second similarity score between (a) the query vector and (b) ones of the second vectors of the second database.

7. The apparatus as defined in claim 6, wherein one or more of the at least one processor circuit is to cause transmission of a prompt to the LLM based on ranked ones of the second vectors having a relatively highest similarity score.

8. The apparatus as defined in claim 7, wherein one or more of the at least one processor circuit is to apply a nearest neighbor algorithm to identify respective ones of the second vectors having the relatively highest similarity score.

9. The apparatus as defined in claim 3, wherein one or more of the at least one processor circuit is to instantiate a sentence transformer to:
generate the first vectors based on the first dimension density; and
generate second vectors corresponding to a second database based on the similarity score not satisfying the similarity threshold value.

10. The apparatus as defined in claim 1, wherein generating the output causes one or more of the at least one processor circuit to render a first graphical user interface (GUI) display.

11. The apparatus as defined in claim 1, wherein one or more of the at least one processor circuit is to embed a success parameter in the respective tuples of the first database.

12. The apparatus as defined in claim 11, wherein one or more of the at least one processor circuit is to:
increment the success parameter of first ones of the respective tuples associated with a positive feedback input; and
decrement the success parameter of second ones of the respective tuples associated with a negative feedback input.

13. The apparatus as defined in claim 1, wherein the first database is a frequently-asked-questions (FAQ) database, the tuples of the FAQ database including a plurality of questions and corresponding answers.

14. At least one non-transitory machine-readable medium comprising machine-readable instructions to cause at least one processor circuit to at least:
generate first vectors corresponding to a first database, the first vectors respectively based on tuples of the first database;
generate a query vector based on a query intended for a large language model (LLM);
determine respective similarity scores between (a) the query vector and (b) the first vectors of the first database;
prevent transmission of the query vector to the LLM based on the similarity score satisfying a similarity threshold value; and
generate an output corresponding to the query vector based on data associated with the first vectors of the first database.

15. The at least one non-transitory machine-readable medium of claim 14, wherein the machine-readable instructions are to cause one or more of the at least one processor circuit to generate the first vectors based on a first dimension density.

16. The at least one non-transitory machine-readable medium of claim 15, wherein the machine-readable instructions are to cause one or more of the at least one processor circuit to generate second vectors corresponding to a second database based on the similarity score not satisfying the similarity threshold value.

17. The at least one non-transitory machine-readable medium of claim 16, wherein the machine-readable instructions are to cause one or more of the at least one processor circuit to generate the second vectors based on a second dimension density greater than the first dimension density.

18. The at least one non-transitory machine-readable medium of claim 16, wherein the machine-readable instructions are to cause one or more of the at least one processor circuit to determine a second similarity score between (a) the query vector and (b) ones of the second vectors of the second database.

19. The at least one non-transitory machine-readable medium of claim 18, wherein the machine-readable instructions are to cause one or more of the at least one processor circuit to cause transmission of a prompt to the LLM based on ranked ones of the second vectors having a relatively highest similarity score.

20. The at least one non-transitory machine-readable medium of claim 19, wherein the machine-readable instructions are to cause one or more of the at least one processor circuit to apply a nearest neighbor algorithm to identify respective ones of the second vectors having the relatively highest similarity score.
